(19) United States
(12) Patent Application Publication
(10) Pub. No.: US 2019/0322012 A1
(43) Pub. Date: Oct. 24, 2019

(54) MANUFACTURE OF STRUCTURAL PANELS

(71) Applicant: Weeks Holdings Pty Ltd, Edinburgh North, South Australia (AU)

(72) Inventors: Kevin William Weeks, Edinburgh North (AU); Paolo Maccabruni, Erba (IT)

(73) Assignee: Weeks Holdings Pty Ltd, Edinburgh North, South Australia (AU)

(21) Appl. No.: 16/314,249

(22) PCT Filed: Jun. 20, 2017
(86) PCT No.: PCT/AU2017/000142

§ 371 Date: Dec. 28, 2018

(30) Foreign Application Priority Data
Jul. 1, 2016 (AU) 2016902601
Mar. 17, 2017 (AU) 2017900945

(51) Int. Cl. B29C 44/58; B29C 44/12; B29C 44/44; B29C 44/60; B29C 44/34

(52) U.S. Cl. CPC B29C 44/58; B29C 44/12; B29K 2025/06; B29C 44/60; B29C 44/3426; B29C 44/445

(57) ABSTRACT

The present disclosure relates to methods, apparatuses, and systems for manufacturing a building element. In one aspect, a molding system for forming a building element is provided. The molding system includes a mold having a base and a lid. The base includes a side wall; an adjustable internal side wall assembly comprising at least two internal side wall segments movable relative to the side wall and the other internal side wall segment and arranged in a piled stack; an end wall; and an adjustable internal end wall assembly comprising at least two internal end wall segments movable relative to the end wall and the other internal end wall segment and arranged in a piled stack. The side wall, the end wall, the floor, the lid, at least one internal end wall segment, and at least one internal side wall segment, co-operatively define a cuboid cavity for molding the building element.

### PRIORITY DOCUMENTS

The present application claims priority from:

Australian Provisional Patent Application No. 2016902601 titled “MANUFACTURE OF STRUCTURAL PANELS” and filed on 1 Jul. 2016; and
Australian Provisional Patent Application No. 2017900945 titled “MANUFACTURE OF STRUCTURAL PANELS” and filed on 17 Mar. 2017;
the content of each of which is hereby incorporated by reference in their entirety.

### INCORPORATION BY REFERENCE

The following publication is referred to in the present application, and its contents are hereby incorporated by reference in its entirety:

Australian Patent Application 2010269125 titled “A PREFABRICATED STRUCTURAL BUILDING FRAME AND METHOD OF MAKING THE SAME”.

### TECHNICAL FIELD

The present disclosure relates to a building element, and to a method, apparatus and system for manufacturing the building element. In a particular form, the present disclosure relates to a system and apparatus for producing building elements comprising a load bearing frame around which an insulating material is moulded.

### BACKGROUND

Australian Patent Application 2010269125 discloses a generally cuboid building element or panel suitable for use as any one of a wall, a floor or a roof panel, and which comprises a structural frame infilled with expanded polystyrene (EPS) foam moulded between and around elements of the frame.

One method for producing building elements of this type comprises the steps of placing the structural frame in a mould, filling the mould with EPS beads, and then supplying steam into the mould, so as to cause the EPS beads to bond to each other and the structural frame.

In cases where it is necessary to produce building elements of varying dimensions (i.e. width, length and depth in particular), either multiple moulds are required, or one mould must be taken offline for a lengthy period of time while its internals are reconfigured to produce a building element of another size.

It is against this background, and the problems and difficulties associated therewith, that the present invention has been developed.

Certain objects and advantages of the present invention will become apparent from the following description, taken in connection with the accompanying drawings, wherein, by way of illustration and example, an embodiment of the present invention is disclosed.

### SUMMARY

According to a first aspect, there is provided a moulding system for forming a building element, the moulding system comprising a mould comprising a base and a lid, wherein the base comprises:
a side wall;
an adjustable internal side wall assembly comprising at least two internal side wall segments arranged in a piled stack, where at least one of these internal side wall segments is movable toward and away from the side wall, and relative to at least the other internal side wall segment;
an end wall;
an adjustable internal end wall assembly comprising at least two internal end wall segments arranged in a piled stack, where at least one of these internal end wall segments is movable toward and away from the end wall, and relative to at least the other internal end wall segment; and
at least one of an adjustable internal floor which is movable toward and away from the lid, or an adjustable internal lid which is movable toward and away from a floor;
and wherein the side wall, the end wall, the floor, the lid, at least one internal end wall segment, and at least one internal side wall segment, co-operatively define a cuboid cavity.
in this way, the mould is configurable to produce a building element having a first thickness.

In one form, in an alternative, the side wall, the end wall, the floor, the lid, each end wall segment, and each internal side wall segment, co-operatively define the cuboid cavity.

In this way, the mould is configurable to produce a building element having a second thickness, which is greater than the first thickness.

In one form, the adjustable internal side wall assembly comprises at least three internal side wall segments arranged in a piled stack, where each segment is movable toward and away from the side wall, and relative to at least a lower segment in the stack.

In one form, the adjustable internal end wall assembly comprises a plurality of internal end wall segments arranged in a piled stack, where each segment is movable toward and away from the end wall, and relative to at least a lower segment in the stack.

In one form, for each internal side wall segment, there is a corresponding internal end wall segment, which together with the adjustable internal floor or lid, the side wall and the end wall co-operatively define a substantially cuboid cavity.

In this way, the mould is adapted to produce building elements having one of at least three different thicknesses.

In one form, the adjustable internal end wall assembly is movable toward and away from the end wall.

In this way, the mould is adapted to produce building elements of varying lengths.

In one form, the adjustable internal side wall assembly is movable toward and away from the side wall.

In one form, each internal end wall segment comprises a first segment portion, and a second segment portion which extends and retracts relative to the first segment portion to bridge any gap between the adjustable internal side wall assembly and the first segment.

In this way, the mould is adapted to produce building elements of varying widths.

In one form, for each internal end wall segment, the second segment portion telescopes with respect to the first segment portion. In an alternative, the segment portion slides behind the first segment portion.

In one form, the lid is pivotally mounted with respect to the base.

In one form, the lid is movable between a closed position, and at least a first open position with respect to the base.

In one form, the lid is movable between the closed position, and a second open position with respect to the base.

In one form, the first open position provides a larger opening than the second open position.

In one form, the end wall is pivotally mounted with respect to a remainder of the base so as to be movable between open and closed positions with respect to the remainder of the base.

In one form, the adjustable internal floor depends from a linear actuator, which in turn depends from the base. In one form, in an alternative, the adjustable internal lid depends from a linear actuator, which in turn depends from the lid.

In one form, each internal side wall segment depends from a linear actuator, which in turn depends from the base.

In one form, the first segment portion of each internal end wall segment depends from a linear actuator, which in turn depends from the base.

In one form, the moulding system comprises a control system.

In one form, the moulding system comprises a steam supply system for supplying steam to the mould.

In one form, the moulding system comprises an EPS supply system for supplying EPS pieces to the mould.

According to a further aspect, there is provided a method for forming a building panel using the above described moulding system, the method comprising the steps of positioning and configuring each of the adjustable internal side wall assembly and the adjustable end wall assembly, and positioning one of the adjustable internal floor or the adjustable internal lid as required to define a cavity, filling the cavity with EPS, and then supplying the cavity with steam to bond the EPS together.

In one form, the method comprises the further step of placing a structural frame in the mould before filling the cavity with EPS.

According to a further aspect, there is provided a mould for moulding a generally cuboid article, the mould comprising:
a side wall;
an adjustable internal side wall assembly comprising at least two internal side wall segments arranged in a piled stack, where at least one of these internal side wall segments is movable toward and away from the side wall, and relative to at least the other internal side wall segment;
an end wall;
an adjustable internal end wall assembly comprising at least two internal end wall segments arranged in a piled stack, where at least one of these internal end wall segments is movable toward and away from the end wall, and relative to at least the other internal end wall segment; and
at least one of an adjustable internal floor which is movable toward and away from the lid, or an adjustable internal lid which is movable toward and away from a floor;
and wherein the side wall, the end wall, the floor, the lid, at least one internal end wall segment, and at least one internal side wall segment, co-operatively define a cuboid cavity.

According to a further aspect, there is provided a mould for moulding a generally cuboid article, the mould comprising:
a side wall;
an adjustable internal side wall assembly;
an end wall;
an adjustable internal end wall assembly; and
at least one of an adjustable internal floor which is movable toward and away from the lid, or an adjustable internal lid which is movable toward and away from a floor;
and wherein the side wall, the end wall, the floor, the lid, the adjustable internal side wall assembly and the adjustable internal end wall assembly co-operatively define a cuboid cavity, where the width and length of this cavity are adjustable within respective ranges, and the thickness of the cavity is selectable from one of at least two alternatives.

In one form, the thickness of the cavity is selectable from one of at least three alternatives.

In one form, the thickness is selectable from one of 132 mm, 200 mm and 300 mm.

In one form, the length range is 6,000 mm to 10,000 mm.

In one form, the width range is 2,400 mm to 3,180 mm.

A detailed description of one or more embodiments of the invention is provided below along with accompanying figures that illustrate by way of example the principles of the invention. While the invention is described in connection with such embodiments, it should be understood that the invention is not limited to any embodiment. On the contrary, the scope of the invention is limited only by the appended claims and the invention encompasses numerous alternatives, modifications and equivalents. For the purpose of example, numerous specific details are set forth in the following description in order to provide a thorough understanding of the present invention.

For ease of description, both a mould and a moulding system embodying the present invention is described below in its usual assembled position as shown in the accompanying drawings, and terms such as front, rear, upper, lower, horizontal, longitudinal etc., may be used with reference to this usual position. However, both the mould and the moulding system may be manufactured, transported, sold, or used in orientations other than that described and shown here.

The present invention may be practiced according to the claims without some or all of these specific details. For the purpose of clarity, technical material that is known in the technical fields related to the invention has not been described in detail so that the present invention is not unnecessarily obscured.

### BRIEF DESCRIPTION OF DRAWINGS

Embodiments of the present invention will be discussed with reference to the accompanying drawings wherein:

FIGS. 1 and 2 are simplified schematic representations of a mould from a moulding system for forming a building element, according to an embodiment;

FIGS. 3 and 4 illustrate a mould for forming a building element, according to an embodiment;

FIGS. 5 and 6 are detail views of the mould of FIGS. 3 and 4, where a lid for the mould is in an open position;

FIG. 7 is a detail view of an openable end wall from the mould;

FIG. 8 is a hinge side view of the mould; and

FIG. 9 is a detail view of an opposing side of the mould.

In the following description, like reference characters designate like or corresponding parts throughout the figures.

### DESCRIPTION OF EMBODIMENTS

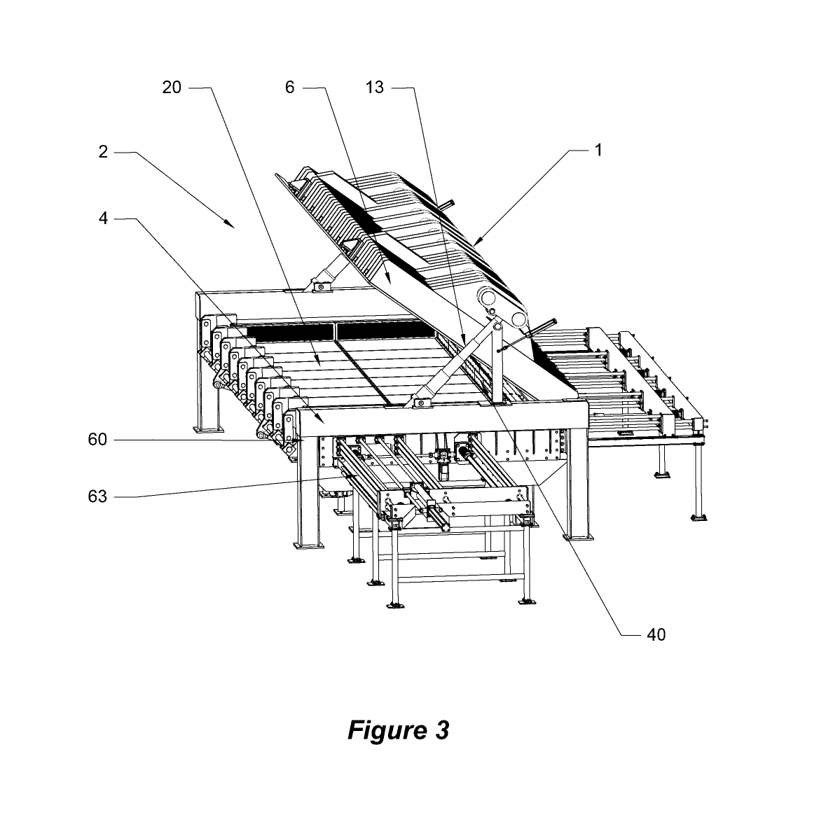

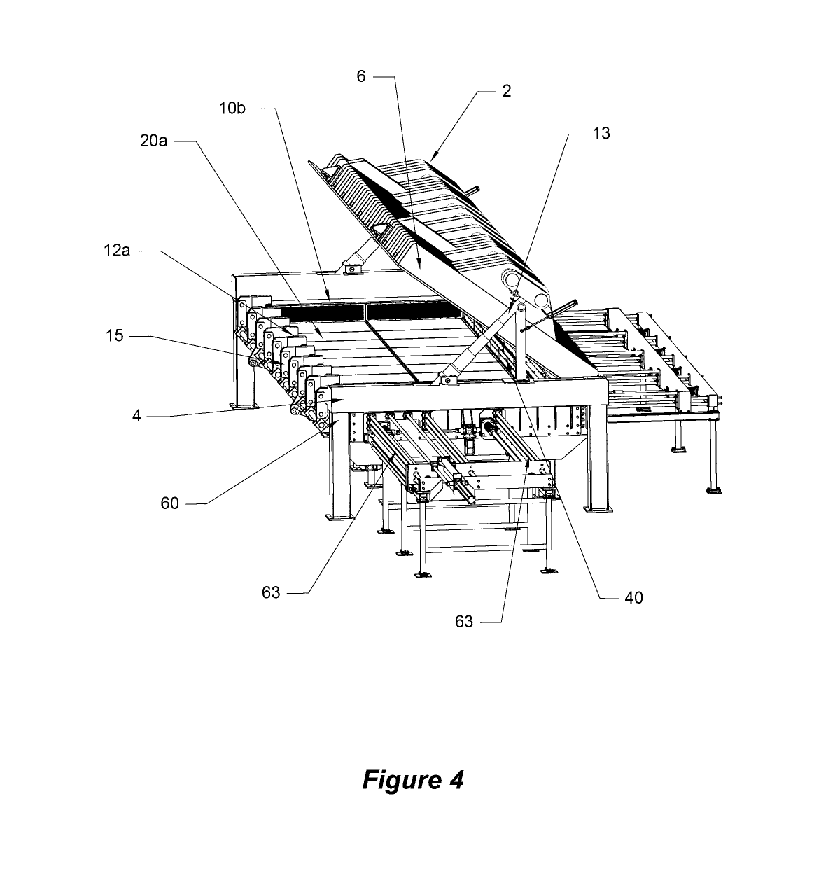

Referring to FIGS. 3 and 4, there is shown a moulding system 1 for forming a building element, the moulding system 1 comprising a mould 2, where the mould 2 comprises a base 4 and a lid 6.

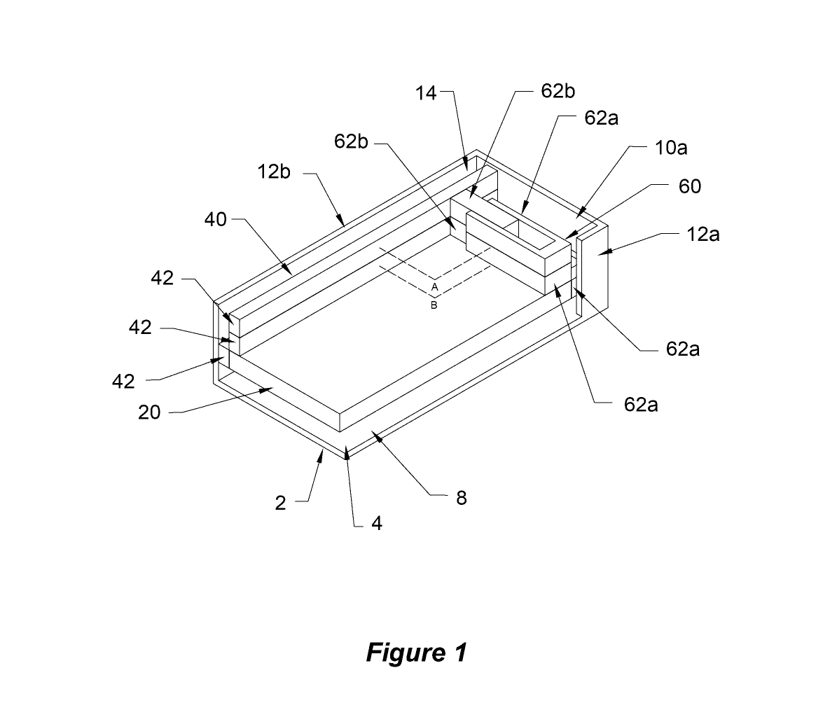

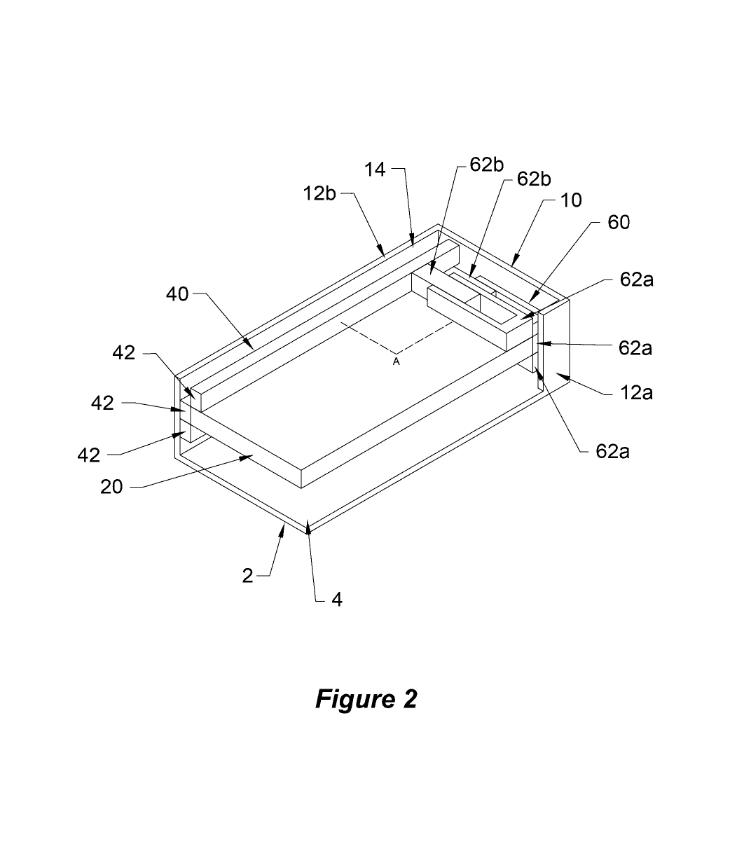

Referring now to FIGS. 1 and 2, the base 4 is a generally cuboid shaped box comprising a floor 8, a pair of end walls 10a and 10b (removed for visibility), a pair of side walls 12a (partially removed for visibility) and 12b, and an opening 14 which is closable by the lid 6.

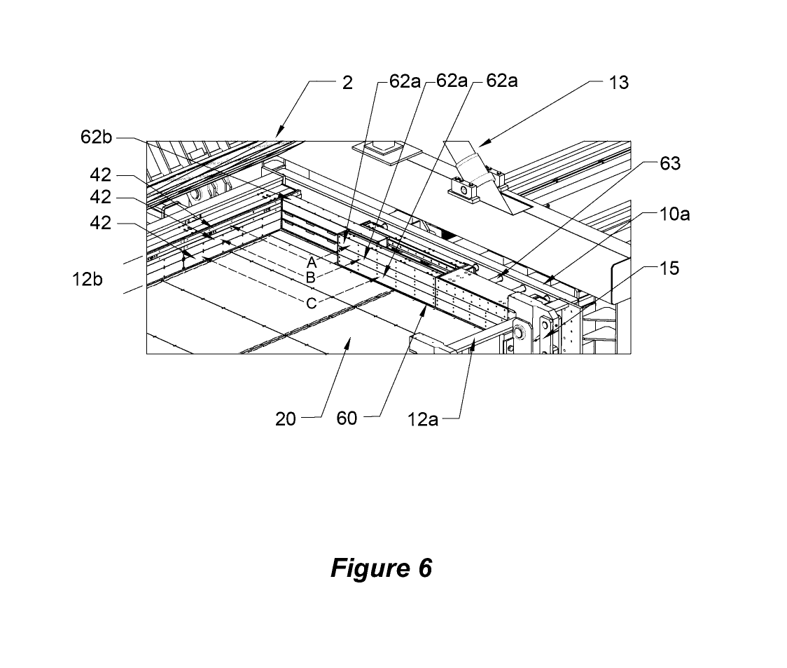

The lid 6 is hinged to side wall 12b (see FIGS. 3 and 4), and linear actuators (hereinafter ‘lid actuators’ 13) move the lid 6 between open and closed positions with respect to the base 4. A selectively releasable locking mechanism depends from side wall 12a, for securing the lid 6 in its closed position. This locking mechanism comprises a plurality of clamps 15 (see FIG. 6), which are spaced apart along the side wall 12a.

In one form, the lid 6 is movable from its closed position, to one of at least two open positions, where a first open position is a substantially open one, providing a larger opening than a second (partial or slightly) open position. In use, the first open position is used to provide access for maintenance operations, whereas the second open position is used as required during a building element forming process or process, to release steam, and/or control cavity temperature, and/or aid ejection of a building element from the mould 2, without significantly affecting cycle times.

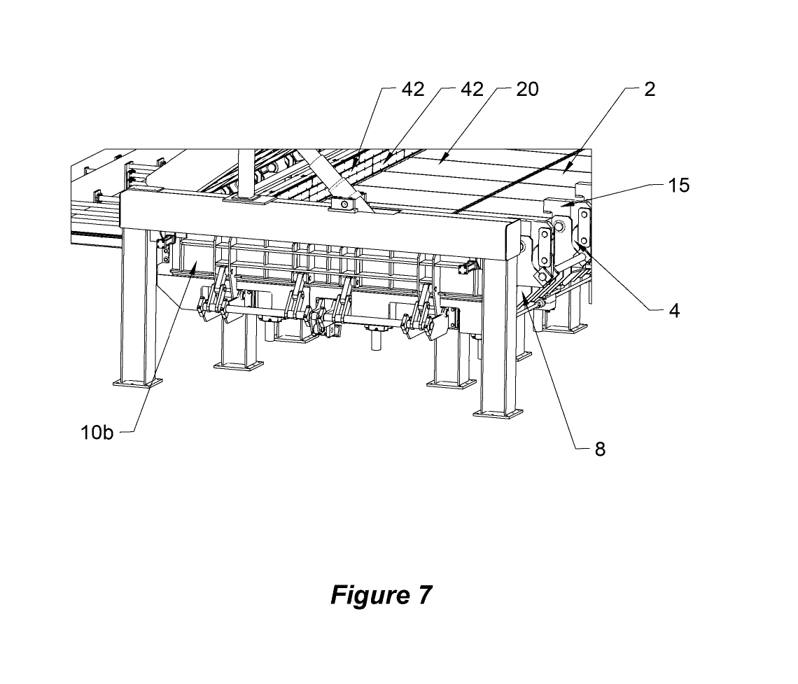

With reference to FIG. 7, it can be seen that the end wall 10b is hinged along a lower edge to the floor 8, and actuators (hereinafter ‘end wall actuators’) move the end wall 10b between open and closed positions with respect to the base 4. When this end wall 10b is in its open position, it creates an opening via which a structural frame can be loaded into the mould 2 cavity, and a completed building element can be unloaded and/or ejected from the mould 2 cavity. These loading and unloading operations can be performed manually, or automated.

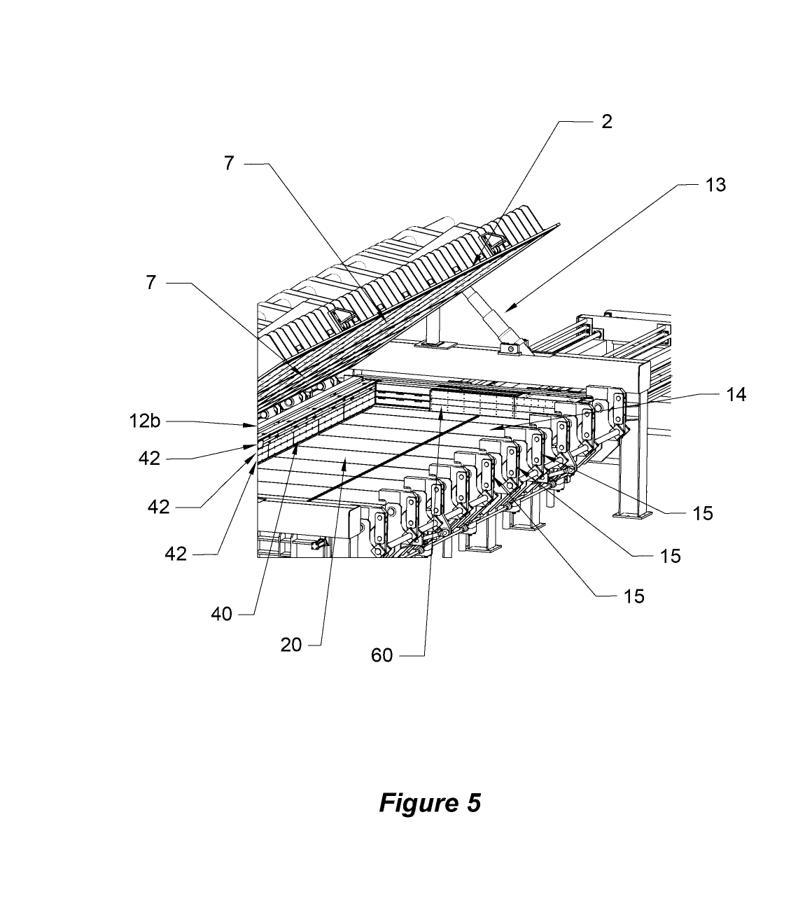

External to the mould 2, the moulding system 1 further comprises a steam supply system 3, and an EPS supply system. When in use, the EPS supply system will supply pieces (beads) of EPS to the mould 2 for release into the mould cavity via a plurality of ports 7 (see FIG. 5) in the underside of the lid 6. Similarly, the steam supply system 3 will, when in use, supply steam to the mould 2 for release into the mould cavity to cause the EPS beads to bond to each other, and to the structural frame positioned in the mould cavity.

The EPS supply system delivers the EPS from a storage hopper (not illustrated) to an array of EPS outlets in the lid 6 via a system of pipes and control valves. These control valves are employed to throttle or shut off supply to selected EPS ports 7 if necessary.

The moulding system 1 further comprises a control system for controlling and coordinating all (or at least some) aspects of operation thereof, including operation of the mould 2, the EPS supply system, the steam supply system, and a mould loader/unloader where this is provided.

The box shaped base 4 of the mould 2 contains an adjustable internal floor 20, an adjustable internal side wall assembly 40, and an adjustable internal end wall assembly 60.

The steam supply system 3 comprises pumps which deliver steam from a boiler to an array of steam outlets in the lid 6, the adjustable internal floor 20, the adjustable internal side wall assembly 40, and the adjustable internal end wall assembly 60, via a system of pipes and control valves.

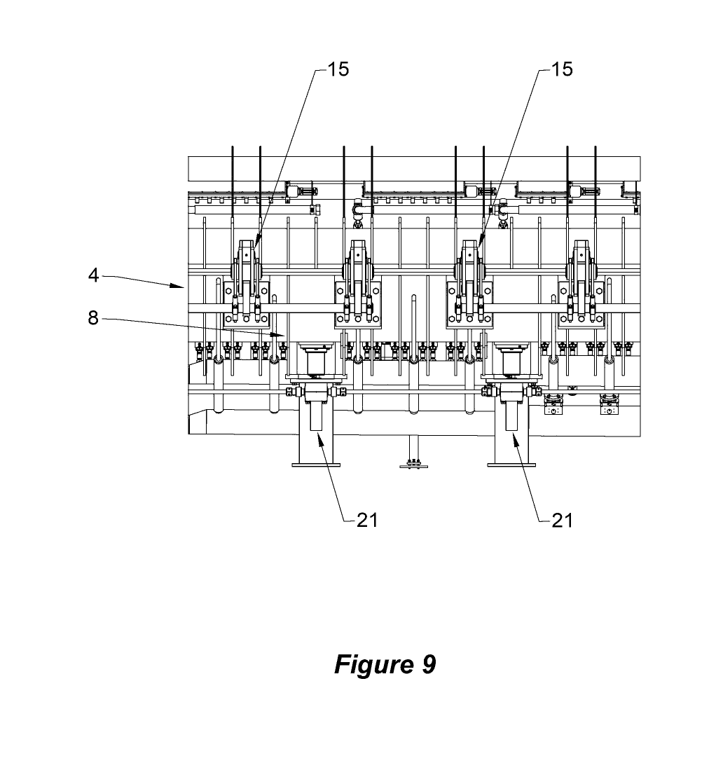

With reference to FIG. 9, it can be seen that the adjustable internal floor 20 depends from a plurality of linear actuators (hereinafter ‘floor actuators’ 21), which in turn depend from the floor 8 of the base 4, so that the adjustable internal floor 20 is movable toward and away from the closed lid 6. The adjustable floor 20 slides against the end wall 10a and side wall 12a, and is located by a corner defined between the end wall 10a and the side wall 12a. This corner provides a datum for production of building elements.

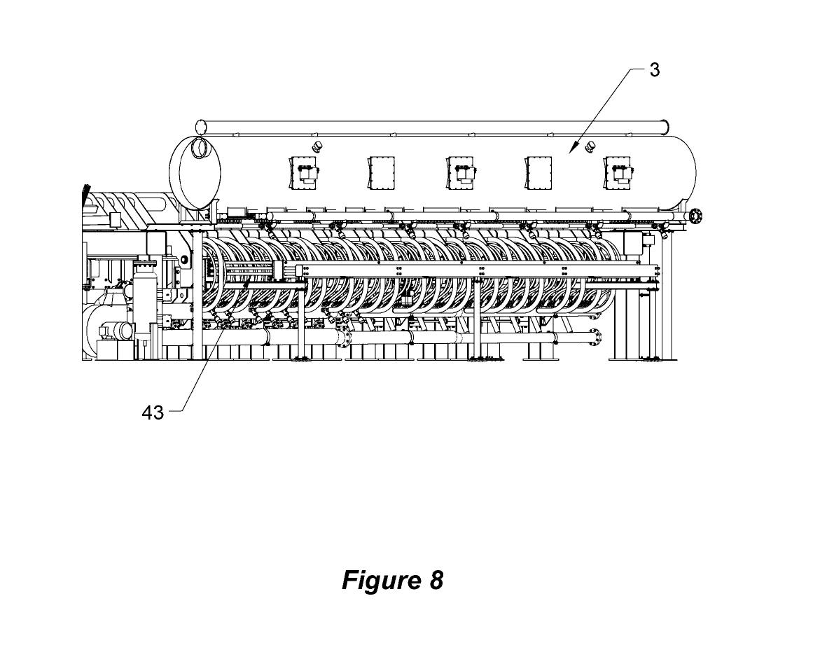

The adjustable internal side wall assembly 40 comprises a plurality of adjustable internal side wall segments 42 arranged in a piled stack. Each adjustable internal side wall segment 42 depends from a plurality of linear actuators (hereinafter ‘side wall segment actuators’ 43—see FIG. 8), which in turn depend from the side wall 12b of the base 4, so that each adjustable internal side wall segment 42 is movable toward and away from the other side wall 12a, and relative to a lower adjustable internal side wall segment 42 in the stack at least.

Depending on the requirements of the specific application, these linear actuators may comprise any one or more of hydraulic rams, pneumatic cylinders, power/lead screws or ball screws. Ball screws offer the advantages of precise positional control and minimal internal friction.

The adjustable internal end wall assembly 60 comprises a plurality of adjustable internal end wall segments 62 arranged in a piled stack. Each adjustable internal end wall segment 62 depends from a plurality of linear actuators (hereinafter ‘end wall segment actuators’ 63—see FIGS. 3 and 4), which in turn depend from the end wall 10b of the base 4, so that each adjustable internal end wall segment 62 is movable toward and away from the other end wall 10a, and relative to a lower segment 62 in the stack at least.

A width W of the mould cavity and thus the building element moulded therein, can be selected by adjusting the spacing between the adjustable internal side wall assembly 40, and the side wall 12a as required.

A length L of the mould cavity and thus the building element moulded therein, can be selected by adjusting the spacing between the adjustable internal end wall assembly 60, and the end wall 10b as required.

Each adjustable internal end wall segment 62 further comprises a first segment portion 62a, and a second segment portion 62b which extends relative to the first segment portion 62b (telescopically like a drawer in this case) to bridge any gap between the first segment portion 62a and the adjustable internal side wall assembly 40.

Each of the second segment portions 62b depends from a linear actuator (hereinafter ‘drawer actuators’), which in turn depends from its respective first segment portion 62a. In use, each of these drawer actuators will drive its respective second segment portion 62b toward the adjustable side wall assembly 40 with its extension, and away from the adjustable side wall assembly 40 with its retraction.

The adjustable internal side wall segments 42 and adjustable internal end wall segment 62 are arranged into pairings comprising one internal side wall segment 42 and one internal end wall segment 62, which are aligned with each other within the base 4, and which comprise a matching depth d.

In the case of the illustrated embodiment, there are three (3) such pairings. It should be understood there could be as few as two (2) such pairings, or more than three (>3) if required. In this case however, there is an uppermost pairing A, a lowermost pairing C, and a central pairing B located between the uppermost pairing A and the lowermost pairing C.

Uppermost pairing A may act alone (as illustrated in FIG. 2) to provide adjustable internal side and end walls 40 and 60 respectively for the mould cavity. Alternatively, uppermost pairing A acts in combination with central pairing B (as illustrated in FIG. 1) to provide internal side and end walls 40 and 60 respectively for the mould cavity. In yet a further alternative, uppermost pairing A acts in combination with central pairing B and lowermost pairing C (as illustrated in FIGS. 5 and 6) to provide internal side and end walls 40 and 60 respectively for the mould cavity.

And so it follows, that a thickness T of the mould cavity and thus the panel moulded therein, can be set by selecting pairing A only, a combination of pairing A and pairing B, or a combination of pairings A, B and C.

A first cuboid cavity for forming a first panel having a first thickness T1, is cooperatively defined between the end wall 10a, the side wall 12a, the adjustable floor 20, the lid 6, and the uppermost pairing A of adjustable side and end wall segments 42 and 62. An upper side of pairing A bears against the lid 6, and the adjustable floor 20 will bear against the underside of pairing A.

A second cavity for forming a second panel having a second thickness T2, which is greater than T1, is cooperatively defined between the end wall 10a, the side wall 12a, the adjustable floor 20, the lid 6, the uppermost pairing A of adjustable side and end wall segments 42 and 62, and the central pairing B of adjustable side and end wall segments 42 and 62. The adjustable floor 20 will bear against the underside of pairing B.

A third cavity for forming a third panel having a third thickness T3, which is greater than T2, is cooperatively defined between the end wall 10a, the side wall 12a, the adjustable floor 20, the lid 6, the uppermost pairing A, the central pairing B and lowermost pairing C of adjustable side and end wall segments 42 and 62. The adjustable floor 20 will bear against the underside of pairing C.

In use, an operator would input into the control system, the size of a building element to be produced in the machine in terms of its width W, length L, and thickness T. A structural frame for that building element would then be loaded and the mould fully closed and clamped. The control system would then set the position of each of the adjustable floor 20, and the required pairings (i.e. one of A, A&B, or A, B&C) of adjustable side and end wall segments 42 and 62. The mould cavity would then be filled with an appropriate volume of EPS, and then the steam would be applied.

Following a short curing time, the end wall 10b would open so that the moulded building element could be removed and/or ejected, such as by one or more of the adjustable internal end wall segments 62 performing an ejection stroke. The process would then restart for a new building element.

Advantageously, the present invention teaches a system and a mould capable of producing building elements of variable width W, length L, and thickness T, and which is adjustable quickly for minimal downtime of the mould and system.

Throughout the specification and the claims that follow, unless the context requires otherwise, the words “comprise” and “include” and variations such as “comprising” and “including” will be understood to imply the inclusion of a stated integer or group of integers, but not the exclusion of any other integer or group of integers.

The reference to any prior art in this specification is not, and should not be taken as, an acknowledgement of any form of suggestion that such prior art forms part of the common general knowledge.

It will be appreciated by those skilled in the art that the invention is not restricted in its use to the particular application described. Neither is the present invention restricted in its preferred embodiment with regard to the particular elements and/or features described or depicted herein. It will be appreciated that the invention is not limited to the embodiment or embodiments disclosed, but is capable of numerous rearrangements, modifications and substitutions without departing from the scope of the invention as set forth and defined by the following claims.

1. A molding system for forming a building element, the molding system comprising:
a mold having a base and a lid, the base comprising:
a side wall;
an adjustable internal side wall assembly comprising at least two internal side wall segments arranged in a piled stack, wherein at least one of the internal side wall segments is movable toward and away from the side wall, and movable relative to at least the other internal side wall segment;
an end wall;
an adjustable internal end wall assembly comprising at least two internal end wall segments arranged in a piled stack, wherein at least one of the internal end wall segments is movable toward and away from the end wall, and movable relative to at least the other internal end wall segment; and
at least one of an adjustable internal floor movable toward and away from the lid, and an adjustable internal lid movable toward and away from a floor;
wherein the side wall, the end wall, the floor, the lid, at least one internal end wall segment, and at least one internal side wall segment co-operatively define a cuboid cavity configured for molding the building element.

2. The molding system of claim 1, wherein the side wall, the end wall, the floor, the lid, each end wall segment, and each internal side wall segment, co-operatively define the cuboid cavity.

3. The molding system of claim 1, wherein the adjustable internal side wall assembly comprises at least three internal side wall segments arranged in a piled stack, and wherein each internal side wall segment is movable toward and away from the side wall, and movable relative to at least a lower segment in the stack.

4. The molding system of claim 1, wherein the adjustable internal end wall assembly comprises at least three internal end wall segments arranged in a piled stack, and wherein each internal end wall segment is movable toward and away from the end wall, and movable relative to at least a lower segment in the stack.

5. The molding system of claim 1, wherein for each internal side wall segment, there is a corresponding internal end wall segment, and wherein, together with the adjustable internal floor or lid, the side wall and the end wall co-operatively define a substantially cuboid cavity.

6. The molding system of claim 1, wherein the adjustable internal end wall assembly is movable toward and away from the end wall.

7. The molding system of claim 1, wherein the adjustable internal side wall assembly is movable toward and away from the side wall.

8. The molding system of claim 1, wherein each internal end wall segment comprises a first segment portion and a second segment portion configured to extend and retract relative to the first segment portion to bridge a gap between the adjustable internal side wall assembly and the first segment.

9. The molding system of claim 8, wherein, for each internal end wall segment, the second segment portion telescopes with respect to the first segment portion.

10. The molding system as in any one of the of claim 1, wherein the lid is pivotally mounted with respect to the base.

11. The molding system of claim 1, wherein the end wall is pivotally mounted with respect to a remainder of the base, such that the end wall is movable between open and closed positions with respect to the remainder of the base.

12. The molding system of claim 1, wherein the adjustable internal floor depends from a linear actuator depending from the base.

13. The molding system of claim 1, wherein the adjustable internal lid depends from a linear actuator depending from the lid.

14. The molding system of claim 1, wherein each internal side wall segment depends from a linear actuator depending from the base.

15. The molding system of claim 8, wherein the first segment portion of each internal end wall segment depends from a linear actuator depending from the base.

16. The molding system of claim 1, further comprising a control system.

17. The molding system of claim 1, further comprising a steam supply system configured for supplying steam to the mold.

18. The molding system of claim 1, further comprising an expanded polystyrene (EPS) supply system configured for supplying EPS pieces to the mold.

19. A method for forming a building panel using the molding system of claim 1, the method comprising:
positioning and configuring each of the adjustable internal side wall assembly and the adjustable end wall assembly;
positioning one of the adjustable internal floor or the adjustable internal lid as required to define a cavity;
filling the cavity with expanded polystyrene (EPS); and then
supplying the cavity with steam to bond the EPS together.

20. The method of claim 19, further comprising placing a structural frame in the mold before filling the cavity with EPS.

21. A mold for molding a generally cuboid article, the mold comprising:
a side wall;
an adjustable internal side wall assembly comprising at least two internal side wall segments arranged in a piled stack, wherein at least one of the internal side wall segments is movable toward and away from the side wall, and movable relative to at least the other internal side wall segment;
an end wall;
an adjustable internal end wall assembly comprising at least two internal end wall segments arranged in a piled stack, wherein at least one of the internal end wall segments is movable toward and away from the end wall, and movable relative to at least the other internal end wall segment; and
at least one of an adjustable internal floor movable toward and away from the lid, and an adjustable internal lid movable toward and away from a floor;
wherein the side wall, the end wall, the floor, the lid, at least one internal end wall segment, and at least one internal side wall segment co-operatively define a cuboid cavity.
